(19) United States
(12) Patent Application Publication
(10) Pub. No.: US 2006/0255182 A1
(43) Pub. Date: Nov. 16, 2006

(54) Pattern forming apparatus and method of manufacturing pattern forming apparatus

(76) Inventors: Katsuya Okumura, Tokyo (JP); Manabu Yabe, Kyoto-shi (JP); Yasuyuki Koyagi, Kyoto-shi (JP); Muneo Harada, Amagasaki-shi (JP); Tomofumi Kiyomoto, Amagasaki-shi (JP)

Correspondence Address: SMITH, GAMBRELL & RUSSELL, 1850 M STREET, N.W., SUITE 800, WASHINGTON, DC, 20036, US

(21) Appl. No.: 11/411,983

(22) Filed: Apr. 27, 2006

(30) Foreign Application Priority Data
May 2, 2005 (JP) 2005-134479(P)

(51) Int. Cl. B05B 1/26; B05B 1/34

(52) U.S. Cl. 239/461; 239/463; 239/483

(57) ABSTRACT

Using a silicon single crystal with (100) plane orientation as a base material, a pectinate portion having a slope portion and a patterning material guiding groove is formed through photolithography process. A liquid reservoir for keeping a patterning material common to tooth portions of the pectinate portion is formed in the same step as a step for forming the guiding grooves. In forming slope portion, anisotropic wet etching allows easy and accurate formation of a slope portion with (111) plane orientation to (100) plane orientation, by taking advantage of differences in speed due to the plane orientations. In addition, by forming a groove portion using anisotropic dry etching, the patterning material guiding groove having a perpendicular sidewall reaching the slope portion may be formed at high accuracy. A pattern forming apparatus with high accuracy and low cost is provided.

### BACKGROUND OF THE INVENTION

1. Field of the Invention

The present invention relates to a pattern forming apparatus and a method of manufacturing the same, and in particular, to an apparatus for forming a pectinate (comb-teeth like) pattern for bulkheads and the like, and a method of manufacturing the same. More specifically, the present invention relates to an apparatus for forming a pattern by discharging a patterning material directly on a substrate on which the pattern is to be formed, and a method of manufacturing the same.

2. Description of the Background Art

In a semiconductor device, various patterns of interconnection and/or elements are formed on a substrate. Conventionally, in order to form such a pattern, a process called photolithography is used. In the photolithography process, a resist is applied to the substrate having a material to be patterned formed on a surface thereof, and drying, exposure, and development of the resist are carried out. The resist is patterned in a predetermined shape, and etching is performed using this resist film as a mask. After this processing, the resist film is removed.

As a material of a patterning target that is formed on the substrate, various materials may be used. For example, when manufacturing a panel for a plasma display apparatus, which is one type of flat panel display apparatuses, a material for bulkheads for separating pixels is coated on an entire surface of the substrate and then patterned.

When forming a pattern of a thick film on the substrate, the photolithography process is typically employed. However, as described above, this photolithography process requires a coater for applying a resist, an exposure apparatus for exposing, a development apparatus for developing, and an etching apparatus for etching processing, and accompanies the problems of the increased number of manufacturing steps and the high product cost. In addition, when changing a type of the pattern, it is necessary to replace a mask related to the pattern formation and to change the settings of conditions of the processing of each apparatus.

Further, as a method of forming a thick film pattern on the substrate, a method called screen-printing is known. In this screen-printing, the patterning material is transported through a screen to form a pattern on the substrate. In this case, in order to obtain a predetermined film thickness, it is necessary to make printing process a plurality of times, and to change fineness of mesh and size of an opening of the screen used in each printing little by little. Thus, throughput decreases and the cost increases due to exchange of the meshes.

Therefore, in recent years, a technique has been proposed with which a patterning material is discharged from a nozzle directly onto the substrate, thereby forming a pattern on the substrate. An example of pattern forming apparatuses utilizing such a nozzle is disclosed in Japanese Patent Laying-Open No. 2003-234063.

In a structure disclosed in Japanese Patent Laying-Open No. 2003-234063, a nozzle unit having a plurality of discharging outlets is utilized. The nozzle unit is disposed near and above the substrate, and this nozzle unit is moved relative to the substrate and discharges a pattern forming material from the discharging outlets concurrently. Each discharge outlet is provided with an exposure light source, with which the pattern forming material is exposed to be cured or hardened immediately after the discharging. The nozzle unit is removably attached to a supporting portion.

Japanese Patent Laying-Open No. 2003-234063 intends to efficiently form a pattern over a wide range on the substrate, by providing the plurality of discharging outlets and discharging the pattern forming material from these discharging outlets at the same time. Further, by removably attaching the nozzle unit to the supporting portion, it is intended to treat different patterns by exchanging the nozzle.

In Japanese Patent Laying-Open No. 2003-234063, ceramic is used for a base material of the nozzle unit in consideration of its machining accuracy and machining cost. Accordingly, mechanical processing such as grinding or cutting is basically employed in forming the nozzles. This causes a problem of lower processing accuracy, as compared with a case in which common photolithography process is employed.

A case in which is bulkheads are formed as a pattern on a rear panel of a plasma display apparatus is now considered. In this case, if pixels are made even finer in order to increase an image resolution, a pitch of the bulkheads for separating phosphor layers should also become finer, and accordingly, a pitch of the discharging outlets that discharge the patterning material are required to be made finer. However, in the mechanical processing, it is difficult to form the discharging outlets that discharge the patterning material at such a fine pitch. This leads to a problem that it is difficult to accommodate for a very fine pattern.

In addition, because the mechanical processing is performed, strength of the nozzle unit may not be sufficiently maintained, possibly leading to destruction due to mechanical impact during the machining processing.

Moreover, because each discharging outlet is formed using the mechanical processing, it is difficult to manufacture a number of nozzle units at the same time. This causes a problem of low manufacturing efficiency and high manufacturing cost.

### SUMMARY OF THE INVENTION

An object of the present invention is to provide a pattern forming apparatus capable of fine-processing at high accuracy and a method of manufacturing the same.

Another object of the present invention is to provide a pattern forming apparatus with reduced manufacturing cost and a method of manufacturing the same.

A pattern forming apparatus according to the present invention includes a single-crystal substrate having first and second main surfaces; a slope portion formed slanting in a predetermined direction from the first main surface of the single-crystal substrate; and a plurality of groove regions formed, at predetermined pitches, into a pectinate shaped form, each groove region being so deep as to reach the slope portion from the second main surface of the single-crystal substrate.

A method of manufacturing a pattern forming apparatus according to the present invention includes the steps of forming a tapered region having a slope portion at a side thereof by applying anisotropic etching to a first main surface of a single-crystal substrate having the first main surface and a second main surface; and forming a plurality of groove regions, through etching from the second main surface, at a predetermined pitch into a pectinate shaped form, each groove region being so deep as to reach the slope portion.

By employing the single-crystal substrate, it is possible to apply processing using photolithography process and fine-processing at high accuracy, and to implement the apparatus forming a fine-pattern at high accuracy.

Further, because mechanical processing is not necessary, the problem of destruction due to decreased strength of a substrate during the manufacturing process can be eliminated.

In addition, by applying anisotropic etching to the single-crystal substrate, it is possible to form a slope surface according to a crystal surface orientation of the substrate at high accuracy. Also, with the groove regions, it is possible to form the discharging outlets at high accuracy at a desired pitch.

Moreover, by employing the single-crystal substrate, it is possible to manufacture a plurality of forming apparatuses (nozzle units) concurrently using a single-crystal wafer, and therefore to reduce the manufacturing cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view schematically showing a structure of a nozzle unit according to a first embodiment of the present invention;

FIG. 2 is a top view of the nozzle unit shown in FIG. 1;

FIG. 3 is a side view of the nozzle unit shown in FIG. 1;

FIG. 4 is a front view of the nozzle unit shown in FIG. 1;.

FIG. 5 is an enlarged view of a slope portion of the nozzle unit shown in FIG. 1;

FIG. 6 is a view schematically showing an arrangement of the nozzle unit shown in FIG. 1 when forming a pattern;

FIG. 7 is a view schematically showing an arrangement of a pattern forming apparatus adopting the nozzle unit according to the present invention;

FIG. 8 is a sectional view showing a manufacturing step of the nozzle unit according to the first embodiment of the present invention;

FIG. 9 is a sectional view showing a manufacturing step of the nozzle unit according the present invention;

FIGS. 10A and 10B are views showing respective structures of a front surface and a back surface of a single-crystal substrate shown in FIG. 9;

FIG. 11 is a cross-sectional view showing a manufacturing step of a pattern forming apparatus according to the first embodiment of the present invention;

FIG. 12 is a view schematically showing a pattern of a silicon dioxide film in the manufacturing step of in FIG. 11;

FIG. 13 is a cross-sectional view showing a manufacturing step of the nozzle unit according to an embodiment of the present invention;

FIG. 14 is a view schematically showing a pattern of a photoresist film shown in FIG. 13;

FIG. 15 is a view schematically showing a cross-sectional structure of the pattern forming apparatus shown in FIG. 14 after completion of etching;

FIG. 16 is a view schematically showing a planar structure of the nozzle unit included in the pattern forming apparatus shown in FIG. 15, viewed from a second main surface;

FIGS. 17A and 17B are views schematically showing cross-sectional structures of the nozzle unit taken along lines XVIIA-XVIIA, and XVIIB-XVIIB shown in FIG. 16, respectively;

FIG. 18 is a sectional view showing a manufacturing step of the nozzle unit according the present invention;

FIGS. 19A and 19B are views schematically showing structures of the nozzle unit included in the pattern forming apparatus shown in FIG. 18 viewed from a front surface and a rear surface, respectively;

FIGS. 20A and 20B are views schematically showing cross-sectional structures taken along lines XXA-XXA, and XXB-XXB shown in FIGS. 19A and 19B, respectively; and

FIG. 21 is a view schematically showing a structure of the nozzle unit after completion of the manufacturing process.

### DESCRIPTION OF THE PREFERRED EMBODIMENTS

### First Embodiment

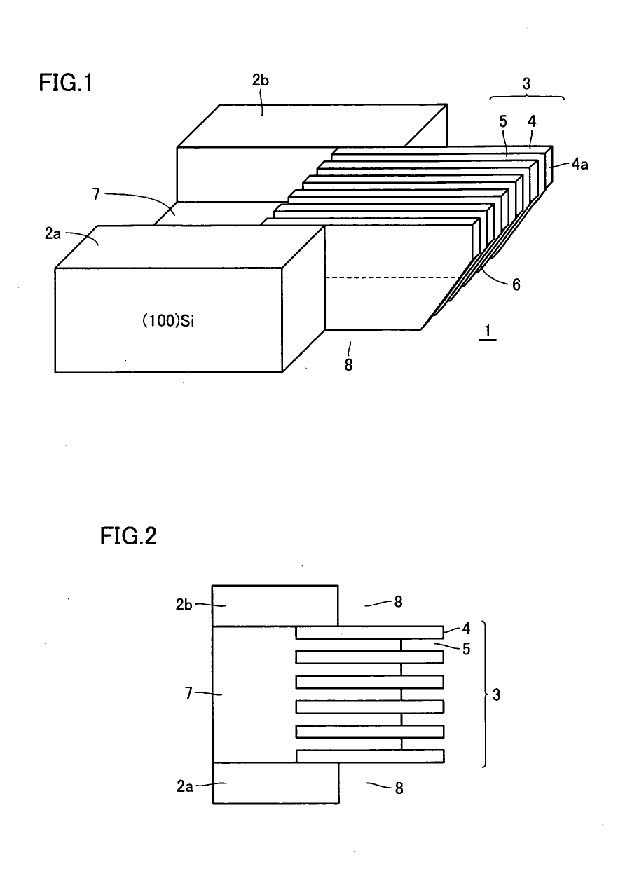

FIG. 1 is a view schematically showing a structure of a nozzle unit according to a first embodiment of the present invention. A pattern forming apparatus shown in FIG. 1 is a patterning material discharge apparatus for discharging a patterning material. Using the discharge apparatus shown in FIG. 1, a patterning material in paste state is discharged on a substrate, and the discharged patterning material is cured through irradiation of energy such as ultraviolet ray, to form a pattern in a line form on the substrate.

A single pattern forming apparatus main body is constructed using a plurality of the patterning material discharge apparatuses shown in FIG. 1. Therefore, in the following description, the apparatus shown in FIG. 1 is referred to as a nozzle unit because the patterning material is discharged therefrom.

In FIG. 1, a nozzle unit 1 is formed by a silicon single crystal as a base material, and includes side frame portions 2a and 2b that define a region for discharging the patterning material, and a pectinate (comb-teeth shaped) portion 3 that discharges the patterning material. This pectinate portion 3 includes a plurality of groove portions 5 formed at predetermined pitches and tooth portions 4 defining the groove portions. At pectinate portion 3, a slope portion 6 is formed for allowing nozzle unit 1 to be placed facing the substrate on which the pattern is formed, to discharge the patterning material.

As shown by dotted line in FIG. 1, each groove portion 5 is formed deep to reach slope portion 6. As an example, a height of an end surface 4a of each tooth portion 4 is 250 μm, a width of groove portion 5 is 280 μm, and a tooth width of tooth portion 4 is 90 μm. Groove portions 5 are positioned at constant pitches (90 μm) by tooth portions 4, and the width of tooth portion 4 defines the pitch of the pattern to be formed. An example of the depth of groove portion 5 is 350 μm (shown by dotted line in FIG. 1). By forming groove portion 5 so as to reach the slope portion 6, the patterning material can be discharged from a tip of slope portion 6, so that the patterning material may be discharged from a position close to the substrate.

Nozzle unit 1 further includes a liquid reservoir 7 provided between side frame portions 2a and 2b commonly to all groove regions 5 of pectinate portion 3, and a cut-away portion 8 formed for each of side frame portions 2a and 2b. A depth of liquid reservoir 7 is substantially the same as the depth of groove portion 5 (350 μm), so that the patterning material may be held and supplied.

A length of cut-away portion 8 (length in horizontal direction in FIG. 1) is longer than the height of the pattern to be formed in the pattern formation. In the pattern forming apparatus, a plurality of nozzle units 1 are formed in order to form a pattern over a wide range on the substrate. In this structure, nozzle units 1 are disposed in a plurality of rows so that the patterns to be formed may be arranged at the same pitch. In this case, it is necessary to prevent the pattern formed by nozzle unit 1 that is positioned in a preceding row (front row) in a moving direction of nozzle units 1 from being interfered (deformation or destruction of the pattern) by nozzle unit 1 that is positioned in a subsequent row (back row). By aligning cut-away portion 8 of nozzle unit 1 in the back row with the discharging outlet (groove region) of the nozzle unit in the front row, the nozzle unit in the back row passes over the pattern formed by the nozzle unit in the front row without affecting (without interfering) the pattern owing to cut-away portion 8. With this, it is possible to form the pattern at the pitch of groove portions 5 (discharging outlets).

Further, by using side frame portions 2a and 2b having sufficient width and thickness, mechanical strength of nozzle unit 1 is ensured.

This nozzle unit 1 is formed by the silicon single crystal as the base material, and capable of forming pectinate portion 3 at high accuracy through the use of photolithography process.

FIG. 2 is a top view of nozzle unit 1 shown in FIG. 1. As show in FIG. 2, nozzle unit 1 includes side frame portions 2a and 2b and liquid reservoir 7 formed between these side frame portions 2a and 2b. This liquid reservoir 7 is concatenated to a bottom portion of groove portion 5. In pectinate portion 3, tooth portions 4 are formed at a predetermined pitch so as to define groove portions 5. Adjacent to this pectinate portion 3, cut-away portion 8 is formed corresponding to each of side frame portions 2a and 2b.

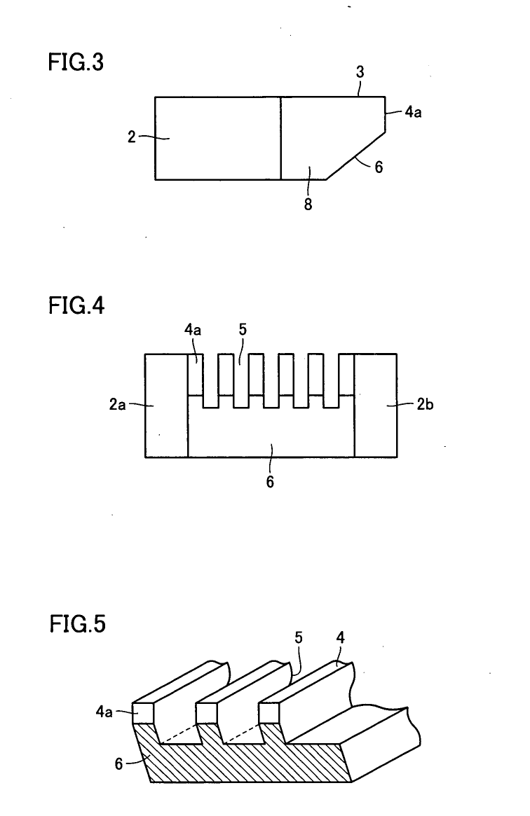

FIG. 3 is a side view nozzle unit 1 shown in FIG. 1. As shown in FIG. 3, nozzle unit 1 includes side frame portion 2, cut-away portion 8 adjacent to side frame portion 2, slope portion 6 formed at a bottom portion of pectinate portion 3, and an end surface 4a of the tooth portion of pectinate portion 3 defining an end of slope portion 6.

FIG. 4 is a front view of nozzle unit 1 shown in FIG. 1. As shown in FIG. 4, nozzle unit 1, seen from anterior, has side frame portions 2a and 2b formed on both sides thereof, and slope portion 6 formed between side frame portions 2a and 2b. Groove region 5 is formed so as to reach slope portion 6, and tooth portion 4 intersects at end surface 4a thereof with slope portion 6.

FIG. 5 is an enlarged view of an area around slope portion 6 of nozzle unit 1 shown in FIG. 1. As shown in FIG. 5, slope portion 6 is terminated by tooth portion end surface 4a. Groove region 5 is formed so as to reach (to intersect with) this slope portion 6. Tooth portions 4 are formed at predetermined pitches.

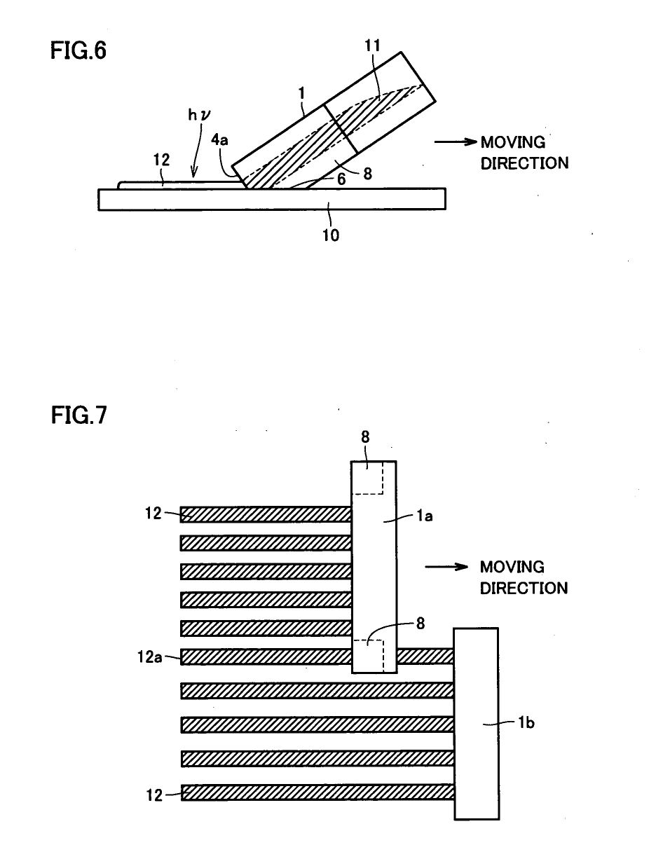

FIG. 6 is a view schematically showing an arrangement of nozzle unit 1 shown in FIG. 1 when forming the pattern. Nozzle unit 1 is arranged to be inclined in the moving direction so that the slope portion 6 may contact with and be parallel with substrate 10. In FIG. 6, a patterning material 11 is discharged toward substrate 10 from nozzle unit 1, and this patterning material 11 is cured immediately after the discharge by light energy hν, such as ultraviolet ray, from a light source that is not shown in the figure. Cut-away portion 8 formed at nozzle unit 1 is, as will be described later, provides a space through which a pattern formed by another nozzle unit passes.

In application to a plasma display apparatus, this substrate 10 is a glass substrate, and patterning material 11 is, by way of example, glass or ceramic powder mixed with a resin containing an ultraviolet curable resin. After this patterning material 11 is discharged, patterning material 11 is cured by irradiating light energy hv, such as ultraviolet radiation, to form a pattern 12 (bulkheads), thereby preventing the pattern from being deformed (made dull) over time to cause pattern misalignment. After the formation of pattern 12, organic material of the pattern is removed by annealing.

In this nozzle unit 1, tooth portion end surface 4a is formed. In order to prevent light energy hv from irradiating onto patterning material 11 that flows in the groove portion of this nozzle unit 1, this tooth portion end surface 4a may be utilized. The configuration for preventing the patterning material from being cured at the patterning material discharging outlet is provided integrally with the light source for irradiating the light energy, and any particular member for shielding the light energy is not provided in this nozzle unit 1.

FIG. 7 is a view showing an example of an arrangement of the nozzle unit in the pattern forming apparatus. In FIG. 7, nozzle units 1a and 1b are disposed in two rows. Along the moving direction, nozzle unit 1b is disposed in the front row, and nozzle unit 1a is disposed in the back row. Nozzle unit 1a has cut-away portions 8 formed on both sides. Nozzle unit 1b that is in the front row is not particularly provided with a cut-away portion. However, a cut-away portion may be provided for this nozzle unit 1b in the front row (all nozzle units may have the same configuration and manufactured using the same manufacturing process). Cut-away portion 8 of nozzle unit 1a in the back row is positioned so as to align with the groove that forms the patterning material discharging outlet of nozzle unit 1b.

As shown in FIG. 7, nozzle units 1a and 1b discharges the patterning material at the same time to form pattern 12. In order to form pattern 12 at the same pitch, nozzle units 1a and 1b are arranged so that their end portions overlap each other along the moving direction. In an region where nozzle units 1a and 1b overlap along the moving direction, nozzle unit 1b in the front row discharges the patterning material to form a pattern 12a. In this case, nozzle unit 1a in the back row crosses over pattern 12a. In this situation, if nozzle unit 1a in the back row is brought into contact with pattern 12a, pattern 12a deforms, and it is not possible to perform accurate patterning. In order to prevent nozzle unit 1a from interfering pattern 12a, cut-away portion 8 is provided. With this cut-away portion 8, side frame portion 2a or 2b passes above pattern 12a, thereby preventing the interference to pattern 12a. Accordingly, it is possible to form patterns 12 at fine pitches.

Forming this nozzle unit 1 using a single crystal according to a general photolithography process employed in manufacturing an integrated circuit device improves productivity and processing (machining) accuracy, and reduces manufacturing cost. Although a plurality of nozzle units are formed on a single wafer concurrently, a manufacturing process of a single nozzle unit is described below in detail. In addition, although liquid reservoir 7 may be formed as a separate member, in the following description of the manufacturing process, the manufacturing process for the structure with liquid reservoir 7 being formed in nozzle unit 1 will be described.

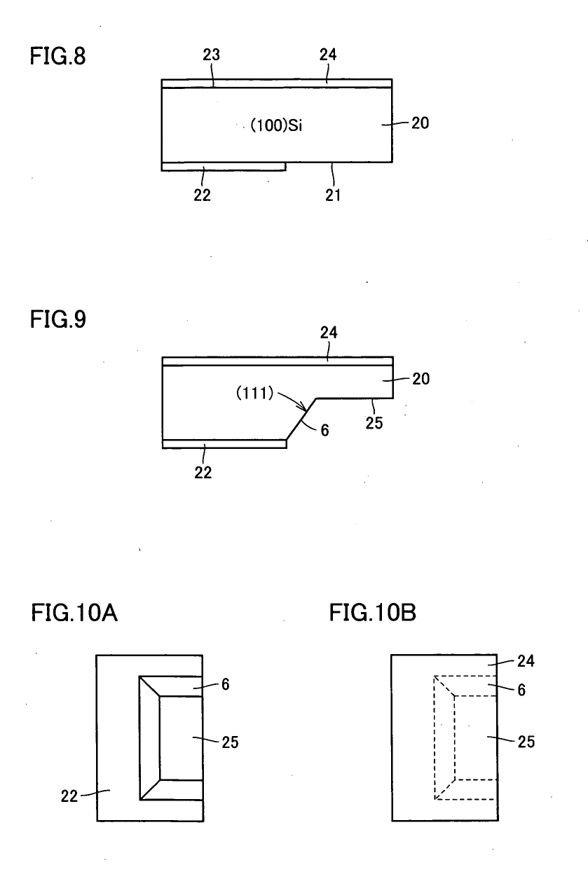

FIG. 8 schematically shows a cross-sectional structure of the nozzle unit in the manufacturing process according to the first embodiment of the present invention. This nozzle unit is formed using a silicon wafer that has both the main surfaces polished. This wafer has a (100) plane orientation. An etching mask film 22 is formed on a predetermined region on a first main surface 21 of a single-crystal substrate 20, and an etching mask film 24 is formed over an entire surface of a second main surface 23 of single-crystal substrate 20 in the same manner. In a case where KOH is used as an etchant, these etching mask films 22 and 24 are of silicon nitride films (SiN films), formed using reduced (low pressure) CVD (chemical vapor deposition) process, for example.

Etching mask film 22 formed on first main surface 21 covers only where the cut-away portions and the side frame portions are to be formed. On the other hand, etching mask film 24 formed on second main surface 23 is formed to cover an entire surface of single-crystal substrate 20. That is, after forming the silicon nitride films to be etching masks on both surfaces of single-crystal substrate 20 according to low-pressure CVD process, a resist film is formed on the silicon nitride film formed on first main surface 21, other than a region where a tapered region including the slope portion is to be formed. Then, etching is performed using the resist film as a mask to remove the silicon nitride film, for exposing first main surface 21. Accordingly, the region where the slope portion to be formed is delimited.

After completing the step of exposing first main surface 21, the resist film used for patterning the etching mask film 22 is removed, and then, cleaning and drying of the surface is performed. Next, using etching mask films 22 and 24 as masks, silicon anisotropic etching is performed. As an etchant, KOH (potassium hydroxide) solution is used, and the wafer is immersed in the KOH silicon etching solution.

Etching mask films 22 and 24 constituted of the silicon nitride films do not dissolve into the etching solution, and therefore, etching is performed to the exposed portion of first main surface 21 according to the etchant. Etching speed of silicon single crystal 20 varies depending on plane orientation, and etching is hardly performed in (111) plane orientation. Thus, it is possible to apply anisotropic etching to accurately expose a plane surface with (111) plane orientation, and to form slope portion 6 at a predetermined angle (about 54 degrees) to first main surface 21. After the etching is completed, the tapered region is formed which is comprised of slope portion 6 and a bottom portion 25 with (100) plane orientation and concatenated with the slope portion.

FIG. 10A is a schematic view showing a structure seen from the first main surface after the completion of the step shown in FIG. 9. As shown in FIG. 10A, with etching mask film 22 formed on the first main surface of silicon single crystal substrate 20, slope portion 6 is formed in a lateral U-shaped form, and this slope portion 6 reaches bottom portion 25. That is, by applying anisotropic etching to the first main surface by forming the silicon nitride film having a rectangular-shaped opening as the etching mask film, etching is applied to a region where etching mask film 22 is not formed, thereby forming the tapered portion having the predetermined angle.

FIG. 10B is a view showing the structure seen from the second main surface after the completion of the manufacturing step shown in FIG. 9. As shown in FIG. 10B, because an entire surface of the second main surface has been covered with etching mask film 24, the surface thereof is not etched at all. With the etching from the first main surface, the tapered region in a truncated pyramid shape having slope portion 6 and bottom portion 25 as shown by the dotted line is formed.

A thickness of silicon single crystal substrate 20 from bottom portion 25 to the second main surface is about 250 μm, and defines a length in height direction of end surface 4a of the tooth portion of the pectinate portion shown in FIG. 5, for example.

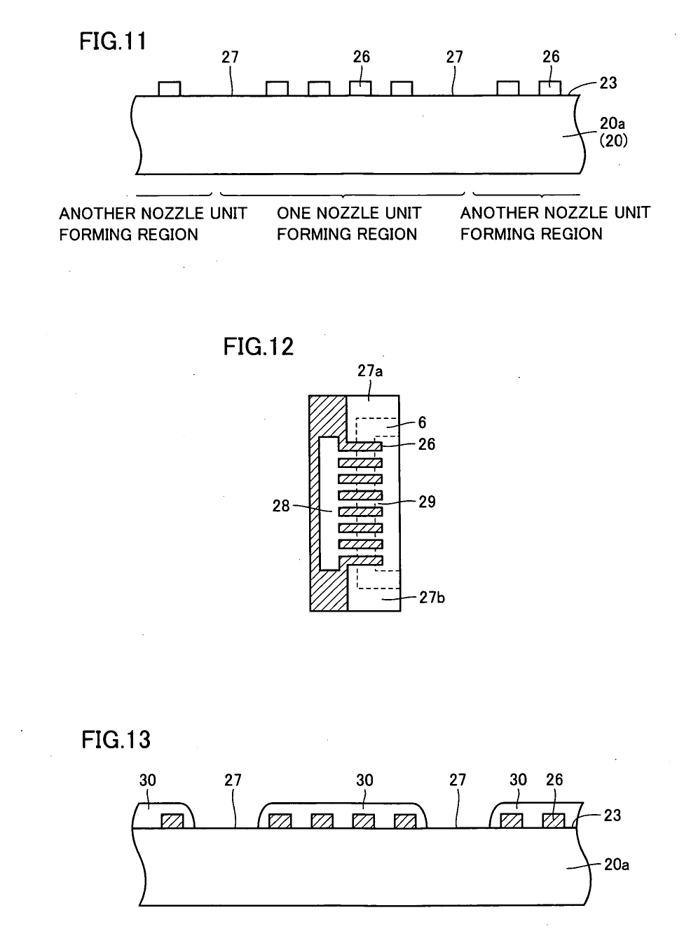

Next, after removing silicon nitride films (etching mask films) 22 and 24, as shown in FIG. 11, a silicon dioxide film (SiO₂) is formed on a predetermined region in the forming region for each nozzle unit on wafer 20a, in order to form the pectinate portion according to thermal oxidation method, for example. Here, for example, after the silicon dioxide film is formed on second main surface 23 of silicon wafer 20a using a thermal oxidation method or the like, silicon dioxide film 26 is left in a region excluding where the pectinate portion and the liquid reservoir are to be formed, using photolithography and etching. FIG. 11 shows silicon dioxide film 26 provided for the pectinate portion.

On this wafer 20a, a plurality of nozzle units are formed, and therefore silicon dioxide film is not formed in a region 27 where each cut-away portion is to be provided, and second main surface 23 is exposed. Here, although the slope portion is formed on single-crystal substrate 20 of silicon wafer 20a on which one nozzle unit is formed, the slope portion is not shown in FIG. 11 in order to simplify the drawing.

FIG. 12 is a view schematically showing the pattern of the one nozzle unit of silicon dioxide film 26. As shown in FIG. 12, silicon dioxide film 26 is formed on the second main surface excluding cut-away portion forming regions 27a and 27b, a liquid reservoir forming region 28, and a groove-portion forming region 29. This silicon dioxide film 26 is patterned so as to form the cut-away portion over slope portion 6 that is formed on the first main surface side. That is, a slant is not formed in the cut-away portion, and the patterning is performed such that an end portion of the cut-away portion (side frame portion) is formed at a position sufficiently higher than the pattern to be formed (bulkheads). Further, because silicon dioxide film 26 is formed such that the groove is formed so as to intersect the slope at the pectinate portion, silicon dioxide film 26 is formed traversing slope portion 6a when viewed in a planar layout. Therefore, silicon dioxide film 26 is formed only where the side frame portions and the tooth portions of the pectinate portion are to be formed.

Next, as shown in FIG. 13, in a state in which this silicon dioxide film 26 is patterned, in order that cut-away portion 27 is exposed, a resist film 30 is formed as a second etching mask on second main surface 23 of wafer 20a so as to cover a second silicon dioxide film 26. This resist film 30 is formed on the entire surface of second main surface 23 by patterning a photoresist film by exposing, developing, and etching, after formed through, for example, spin coating. This resist film 30 may be another film that is resistant to silicon dry etching, other than the photoresist film.

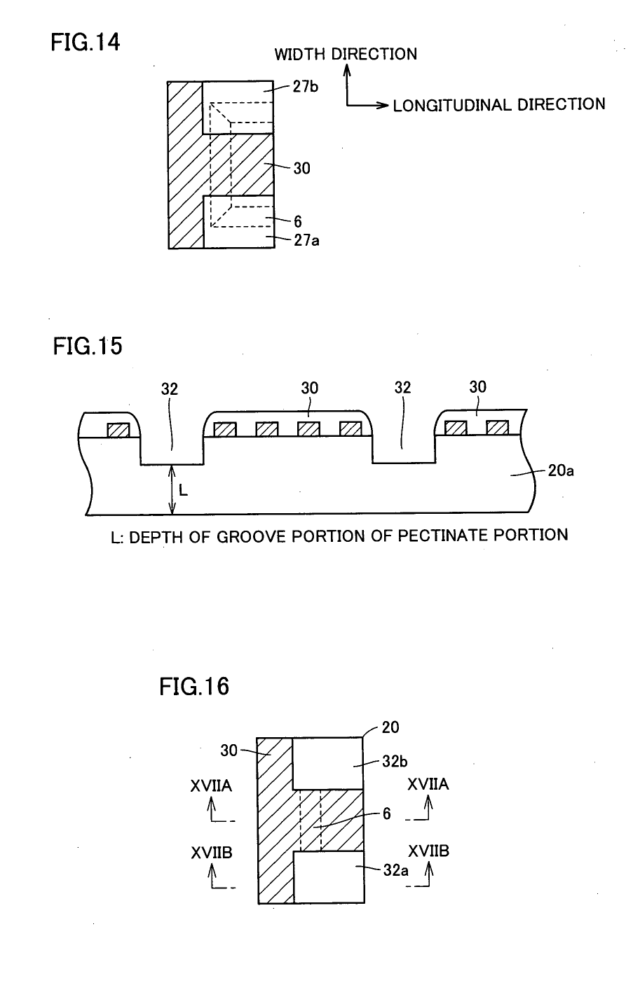

FIG. 14 is a view schematically showing a pattern for one nozzle unit of resist film 30 shown in FIG. 13. As shown in FIG. 14, resist film 30 is patterned such that cut-away portion forming regions 27a and 27b are exposed. This resist film 30 is longer than slope portion 6, in longitudinal direction, and shorter than slope portion 6, in width direction.

Anisotropic etching is applied using this resist film 30 as a mask and employing RIE (reactive ion etching), a groove having a film of thickness corresponding to a depth of the groove portion left thereunder is formed in the cut-away portion forming region as shown in FIG. 15. Specifically, as shown in FIG. 15, a groove 32 having a perpendicular sidewall is formed in the cut-away portion forming region in single-crystal substrate (wafer) 20a. Thickness L of the single-crystal substrate (wafer 20a) where this groove 32 is formed is made equal to the depth of the groove portion in the pectinate portion.

FIG. 16 is a view schematically showing a planar structure of the one nozzle unit seen from the second main surface. As shown in FIG. 16, photoresist film 30 is formed in a T-shaped form in single-crystal substrate 20, and grooves 32a and 32b are formed respectively on both sides of the film 30 so as to sandwich the pectinate-portion forming region. In grooves 32a and 32b, slope portion 6 is not formed, and the groove having a perpendicularly upright sidewall portion is formed by RIE anisotropic etching.

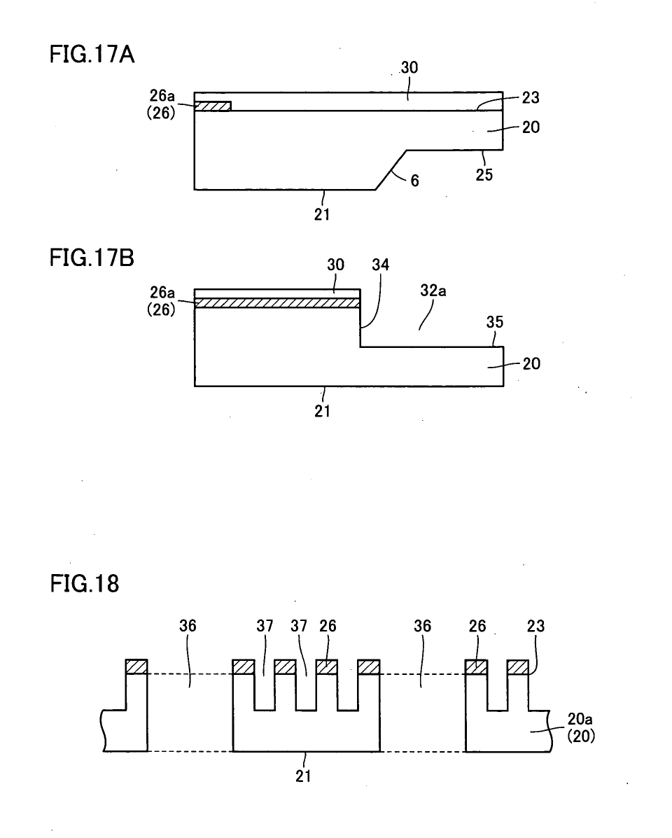

FIG. 17A is a view schematically showing a cross-sectional structure taken along line XVIIA-XVIIA shown in FIG. 16. This line XVIIA-XVIIA corresponds to a section passing over liquid reservoir forming region 28 and groove-portion forming region 29. In FIG. 17A, silicon dioxide film 26a (26) is formed in a predetermined region in second main surface 24 of single-crystal substrate 20. Resist film 30 is formed so as to cover this silicon dioxide film 26a and second main surface 24. In this RIE anisotropic etching, resist film 30 serves as an etching mask, and therefore etching to second main surface 23 is not performed at all in the region shown in FIG. 17A. In addition, because anisotropic etching is applied from second main surface 23 side, first main surface 21, slope portion 6, and bottom portion 25 are also not etched at all.

FIG. 17B is a view schematically showing the cross-sectional structure taken along line XVIIB-XVIIB shown in FIG. 16. This line XVIIB-XVIIB passes over a region where groove 32a corresponding to the cut-away portion forming region is to be formed.

As shown in FIG. 17B, in the predetermined region on single-crystal substrate 20 (side frame portion forming region), silicon dioxide film 26b is formed as a part of the silicon dioxide film pattern, and resist film 30 is formed on this silicon dioxide film 26b. Because a resist film is not formed in a region for forming groove 32a, groove 32a having a perpendicular sidewall 34 and a bottom portion 35 is formed. A thickness between this bottom portion 35 of the groove and first main surface 21 corresponds to the depth of the pectinate portion formed in the next step.

After completing this pre-processing before forming the cut-away portion, resist film 30 is removed and silicon dioxide film 26 is exposed, as shown FIG. 18. RIE anisotropic etching is applied again using this silicon dioxide film 26 as a mask, and the groove region and the liquid reservoir of the pectinate portion are formed. With this anisotropic etching, groove 32 shown previously in FIG. 15 is further etched to form a penetrating region 36. Using this silicon dioxide film 26 as a mask, groove region 37 is formed on second main surface 23. By making a thickness of residual part of cut-away portion in the pre-processing identical with the depth of groove region 37 of the pectinate portion, it is possible to make common the step of forming the cut-away portion and the step of forming the groove and the liquid reservoir in the pectinate portion, thereby simplifying the manufacturing process and reducing the manufacturing time.

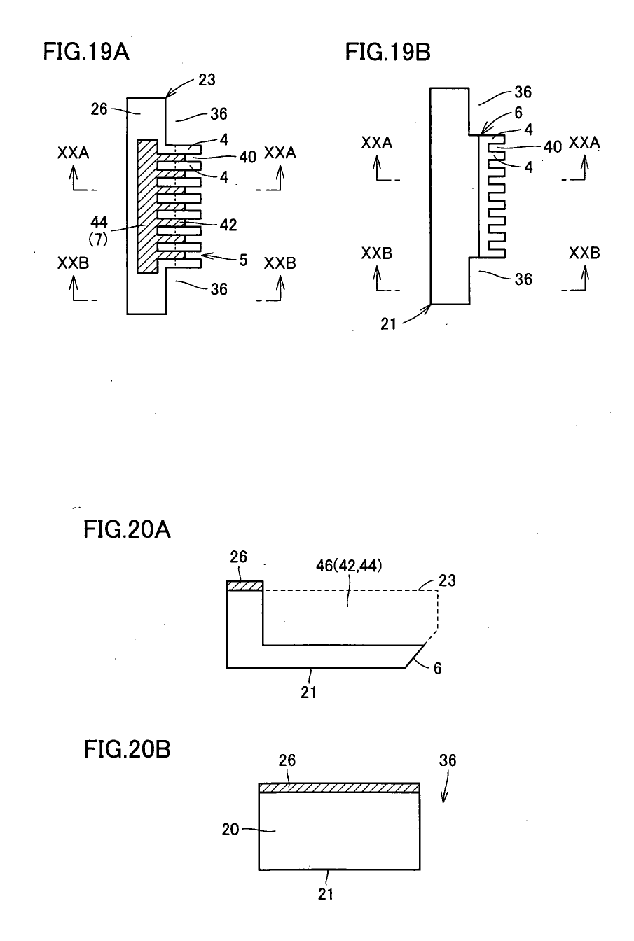

FIG. 19A is a view schematically showing a plane structure of the second main surface after the pectinate portion and the liquid reservoir are formed, and FIG. 19B is a view schematically showing a planar structure seen from the first main surface after the pectinate portion and the liquid reservoir are formed.

In FIG. 19A, on second main surface 23, there are formed rectangular-shaped concave region 44 and groove region 42 concatenated to the rectangular0-shaped concave region 44 to define the groove region of the pectinate portion disposed at a predetermined pitch. In a region excluding these etched regions 42 and 44, silicon dioxide film 26 shown in FIG. 18 is formed. Because silicon dioxide film is not formed at a tip or edge portion of groove region 42, this groove region 42 is shorter than tooth portion 4 of the pectinate portion, and therefore a penetrating region 40 that penetrates between tooth portions 4 is formed at the tip portion of this groove region 42. Thus, the groove region is formed to such a depth as to intersect with slope portion 6, the patterning material is discharged from the tip portion of the slope portion when in discharging the patterning material.

A predetermined number of tooth portions 4 and groove regions 5 are formed at a predetermined pitch, and the cut-away portion 36 is formed on each side of the pectinate portion.

Further, in first main surface 21, as shown in FIG. 19B, first main surface 21 is not etched, through hole 40 is formed at the tip portion of slope portion 6, and the tip portion of tooth portion 4 of the pectinate portion is formed at slope portion 6.

FIG. 20A is a view schematically showing a cross-sectional structure taken along line XXA-XXA shown in FIGS. 19A and 19B. As shown in FIG. 20A, slope portion 6 is formed from first main surface 21 toward second main surface 23, and this slope portion 6 is terminated by penetrating region 40 shown in FIGS. 19A and 19B. An etched region 46 is formed along this slope portion 6, and this etched region 46 corresponds to concave region 44 and groove region 42 shown in FIG. 19A. Further, on the second main surface, silicon dioxide film 26 is formed as the etching mask film and defines a rear region of liquid reservoir 7.

FIG. 20B is a view schematically showing the cross-sectional structure taken along line XXB-XXB shown in FIGS. 19A and 19B. As shown in FIG. 20B, in single-crystal substrate 20, silicon dioxide film 26 is formed on the entire surface thereof as the etching mask film, and the side frame portion is formed thereon. This side frame portion is terminated by the cut-away portion forming region (penetrating region) 36. In a region where this cut-away portion is to be formed, first main surface 21 is flat, and the side frame portion is reliably formed.

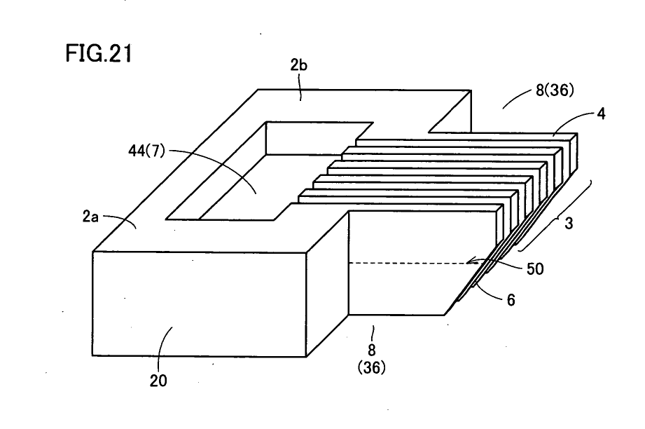

FIG. 21 is a view schematically showing a structure of the nozzle unit after completing the etching using this silicon dioxide film 26 as a mask. After the completion of the etching, silicon dioxide film 26 used as the etching mask film is removed. As shown in FIG. 21, upon completion of manufacturing process of nozzle unit 1, rectangular-shaped concave region 44 constituting liquid reservoir 7 is formed at the center of single-crystal substrate 20, and the bottom portion of this rectangular-shaped concave region 44 is concatenated with bottom portion 50 of the groove of the pectinate portion shown by dotted line in FIG. 21. Side frame portions 2a and 2b are formed on each side of rectangular-shaped concave region 44, and tooth portions 4 of the pectinate portion is formed being concatenated to these side frame portions 2a and 2b. Cut-away portion 8 is formed by through hole region 36 for each of side frame portions 2a and 2b to expose side surfaces of the tooth portion of pectinate portion 3. This tooth portion 4 of pectinate portion 3 is concatenated to slope portion 6.

In the structure of the nozzle unit shown in FIG. 21, liquid reservoir 7 is formed by rectangular-shaped concave region 44. In this case, by using a side of rectangular-shaped concave region 44 opposing to pectinate portion 3 as a dicing line, for dicing the wafer to cut out and separate each nozzle unit, it is possible to form liquid reservoir 7 that is open at one side.

This liquid reservoir 7 may be formed separately by a member (manifold) for supporting the nozzle unit, instead of being formed on the silicon single crystal substrate concurrently and integrally with the groove region. In the case where this liquid reservoir 7 is formed separately by a separate member, only the groove region is formed on the second main surface in this nozzle unit, and as a manufacturing process of the nozzle unit main body, the process as described above can be employed.

By using the silicon single crystal substrate as the base material, it is possible to use photolithography process, and to form pectinate portion 3 and groove portion 6 at high accuracy, thereby implementing a pattern forming apparatus for forming a fine pattern.

Further, the end surface of tooth portion 4 can be formed into a perpendicularly upright shape with accuracy, the sidewall of the groove portion can be structured to be perpendicularly upright, all of the patterning material guiding groove of the pectinate portion can be of the same structure, an amount of the patterning material discharged from each groove can be constant, and the pattern with exactly the same height and width can be formed in forming a pattern in a fine pitch.

Moreover, the wafer has a plurality of nozzle units formed thereon, and processing is performed by a predetermined number of wafers. Therefore, it is possible to manufacture a number of nozzle units concurrently, thereby reducing the manufacturing cost.

The pattern forming apparatus according to the present invention can be used for application of forming a conductive interconnection pattern or application of forming a plurality of line-shaped patterns, in addition to form the bulkheads for a plasma display apparatus. The present invention is advantageously effective in manufacturing a panel for a flat display apparatus in which a number of such patterns are formed.

In addition, the present invention may be used for an other application of forming interconnections using conductive material on semiconductor substrates and wiring boards.

As the patterning material, an appropriate material may be used depending on application. In the above description, the curing (hardening) of the patterning material is performed by light energy such as ultraviolet radiation. However, the curing may be performed by irradiation of electron beam, or may be heated and cured by infrared radiation.

Furthermore, in discharging the patterning material, the slope portion may be disposed so as to be in contact with the pattern forming substrate.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A pattern forming apparatus, comprising:
a single-crystal substrate having first and second main surfaces;
a slope portion formed in a predetermined direction from the first main surface of said single-crystal substrate; and
a plurality of groove regions formed at predetermined pitches and into a pectinate shape, each groove region being so deep as to reach said slope portion from the second main surface of said single-crystal substrate.

2. The pattern forming apparatus according to claim 1, further comprising:
a cut-away portion formed, at an outer side of said plurality of groove regions formed into the pectinate shape, reaching said first main surface from said second main surface.

3. The pattern forming apparatus according to claim 2, further comprising:
a liquid reservoir formed at a predetermined depth from said second main surface and integrated with said plurality of groove regions.

4. The pattern forming apparatus according to claim 1, further comprising:
a liquid reservoir formed at a predetermined depth from said second main surface and integrated with said plurality of groove regions.

5. The pattern forming apparatus according to claim 1, wherein said single-crystal substrate is a silicon single crystal with (100) plane orientation.

6. The pattern forming apparatus according to claim 5, wherein said slope portion has a (111) plane orientation.

7. The pattern forming apparatus according to claim 1, wherein
said slope portion is arranged in parallel with a surface of a substrate on which a pattern is to be formed.

8. A method of manufacturing a pattern forming apparatus using a single-crystal substrate having first and second main surfaces, comprising the steps of:
forming a tapered region having a slant portion at a side thereof by applying anisotropic etching to the first main surface of said single-crystal substrate; and
forming a plurality of groove regions, through application of etching from said second main surface, at predetermined pitches and into a pectinate shape, each groove region being so deep as to reach said slant portion.

9. The method of manufacturing a pattern forming apparatus according to claim 8, further comprising the step of:
forming a liquid reservoir region integrally with said plurality of groove regions, concurrently with the forming of the groove regions.

10. The method of manufacturing a pattern forming apparatus according to claim 8, further comprising the step of:
forming penetrating regions, at both outer sides of said plurality of groove regions, each to reach said second main surface from said first main surface.

11. The method of manufacturing a pattern forming apparatus according to claim 10, further comprising the step of:
forming a liquid reservoir region integrally with said plurality of groove regions, concurrently with said forming of the groove regions.

12. The method of manufacturing a pattern forming apparatus according to claim 10, wherein
the step of forming the penetrating regions includes:
(a) forming a first etching mask for defining, on said second main surface, said plurality of groove regions in the pectinate shape;
(b) forming a second etching mask so as to cover said first etching mask and define the penetrating regions;
(c) applying etching from said second main surface using said second etching mask as a mask;
(d) applying etching, after removing said second etching mask, using said first etching mask as a mask, to form said penetrating regions and said plurality of groove regions concurrently.

13. The method of manufacturing a pattern forming apparatus according to claim 12, wherein
said step (c) includes a step of applying etching from said second main surface to such a depth as to leave a thickness from said first main surface substantially same as a depth to be etched in the step (d).

14. The method of manufacturing a pattern forming apparatus according to claim 8, wherein
said single-crystal substrate is a silicon single crystal with a (100) plane orientation, and
the step of forming the tapered region includes a step of applying anisotropic wet etching.

15. The method of manufacturing a pattern forming apparatus according to claim 8, wherein
the step of forming the plurality of groove regions into the pectinate shape includes a step of applying dry etching to form the groove regions.
